(19) United States
(12) Patent Application Publication
(10) Pub. No.: US 2002/0051251 A1
(43) Pub. Date: May 2, 2002

(54) Handy scanner

(76) Inventor: Tamotsu Senda, Ehime (JP)

Correspondence Address: WENDEROTH, LIND & PONACK, L.L.P., 2033 K STREET N. W., SUITE 800, WASHINGTON, DC, 20006-1021, US

(21) Appl. No.: 09/843,746

(22) Filed: Apr. 30, 2001

(30) Foreign Application Priority Data
May 1, 2000 (JP) 2000-132520

(51) Int. Cl. H04N 1/46

(52) U.S. Cl. 358/505

(57) ABSTRACT

A handy scanner according to the present invention comprises a relay box (USB adapter 1) for relaying signals between the handy scanner and a device, on which relay box a handy scanner body 2 is mounted as shown in FIG. 2.

The so-constructed handy scanner can protect transparent glass disposed on the handy scanner body and can be accommodated in a state where the handy scanner can be easily carried.

### FIELD OF THE INVENTION

The present invention relates to a handy scanner which includes a relay box for connecting a handy scanner body and a device with each other and carrying out processing such as data conversion.

### BACKGROUND OF THE INVENTION

A prior art handy scanner will be described with reference to a figure.

FIG. 3 is a diagram illustrating a structure of the prior art handy scanner.

In FIG. 3, numeral 1 denotes a USB adapter as a relay box, which converts an image signal read by the handy scanner to be compliant with USB interface of a device such as personal computer. Numeral 2 denotes a handy scanner body having transparent glass (not shown) as a read section on its bottom surface. Numeral 3 denotes a USB jack which is connected to a USB terminal included in the device such as personal computer. Numeral 5 denotes a noise filter for reducing interfering electromagnetic waves, which is made of ferrite. Numeral 6 denotes a first cord which connects the handy scanner body 2 and the USB adapter 1 with each other. Numeral 7 denotes a second cord which connects the USB adapter 1 and the USB jack 3 with each other.

The handy scanner manually scans images on an original with using the handy scanner body 2, and outputs the images to the output screen of the personal computer or the like. This handy scanner body 2 reads image light of the original through the transparent glass located on the bottom surface, and signalizes the same. An image signal which is obtained by signalizing the image light goes through the first cord 6 and the USB adapter 1, and is input to the personal computer via the second cord 7 and the USB jack 3. At this time, influences of electromagnetic waves upon the image signal are prevented by the interfering electromagnetic wave reduction noise filter 5 which is attached to the first cord 5.

When the handy scanner and the personal computer can be connected with each other via the USB interface, the USB adapter 1 converts the image signal of the image light which has been read by the handy scanner body 2 so as to be compliant with the USB interface. This USB adapter is connected to the USB terminal of the personal computer via the USB jack 3, and carries out processing such as a process for displaying images which have been read by the handy scanner body 2 on the display screen, on the basis of the converted signal.

However, in the above-mentioned prior art handy scanner, the handy scanner body 2 and the USB adapter 1 are connected via the first cord 6 and the second cord 7, and separately exist. Thus, the prior art handy scanner is inconvenient for storage, and further it occupies much space.

In addition, while the handy scanner body 2 reads the image light of the original through the transparent glass located on the bottom surface, since the transparent glass is disposed in an exposed state, the glass face is easily dirtied or scratched. Further, the dirt or scratch on the transparent glass is a main cause of adverse influences upon the qualities of images to be captured.

In addition, it is required to attach the interfering electromagnetic wave reduction noise filter 5 to the first cord 6, and this noise filter 5 also causes the inconvenience in the storage of the handy scanner.

### SUMMARY OF THE INVENTION

The present invention is made in view of the above-mentioned problems and has for its object to provide a handy scanner which can protect the transparent glass of the handy scanner body and can be accommodated in a state in which the handy scanner is easily carried.

To attain the above-mentioned object, a handy scanner as defined in Claim 1 of the present invention comprises: a handy scanner body having a read section on a bottom surface thereof; a relay box for relaying signals between the handy scanner body and a device; a first cord for connecting the handy scanner body and the relay box with each other; a terminal for establishing connection with the device; and a second cord for connecting the relay box and the terminal with each other, and the handy scanner body is mounted on the relay box.

According to a handy scanner as defined in Claim 2 of the present invention, in the handy scanner as defined in Claim 1, the relay box has a recess which receives the handy scanner body.

According to a handy scanner as defined in Claim 3 of the present invention, in the handy scanner as defined in Claim 1, the relay box contains an interfering electromagnetic wave reduction noise filter.

According to a handy scanner as defined in Claim 4 of the present invention, in the handy scanner as defined in Claim 2, the relay box comprises a fastener for fixing the handy scanner body in a state where the handy scanner body is received in the recess.

### BRIEF DESCRIPTION OF THE DRAWINGS

FIG. 1 is a diagram illustrating a handy scanner according to a first embodiment of the present invention.

FIG. 2 is a diagram illustrating a state where the handy scanner body is mounted on a relay box according to the first embodiment of the present invention.

FIG. 3 is a diagram illustrating a prior art handy scanner.

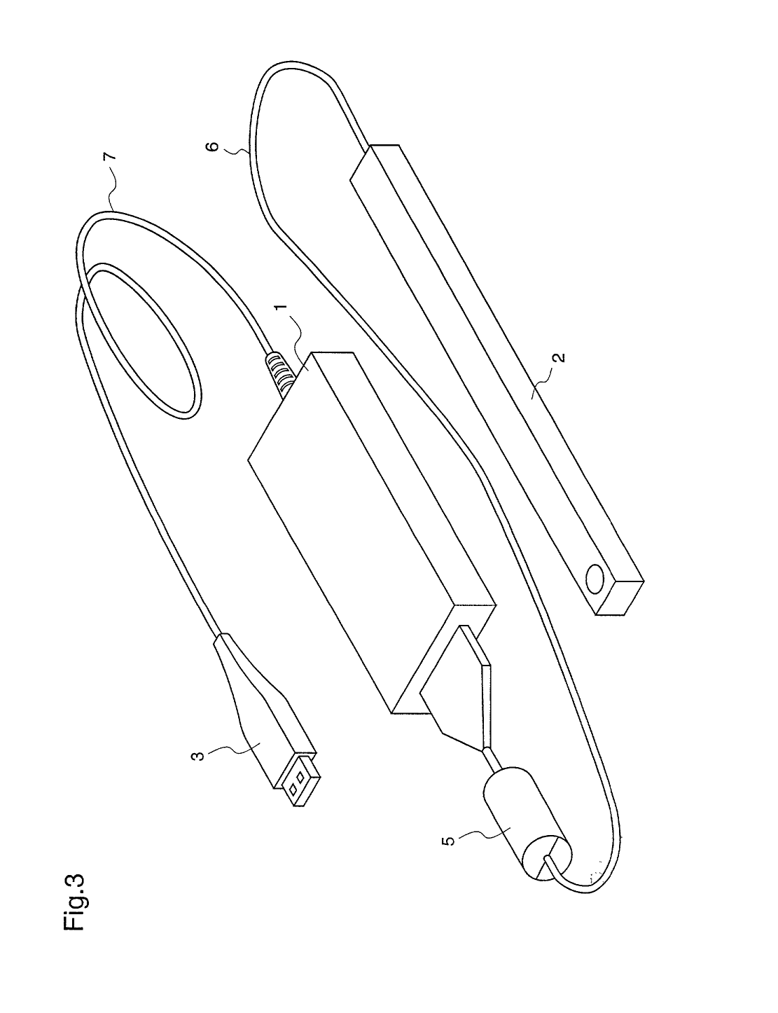

### DETAILED DESCRIPTION OF THE PREFERRED EMBODIMENTS

Hereinafter, an embodiment of the present invention will be described with reference to the drawings. In all figures, the same reference numerals denote the same or corresponding elements.

Embodiment 1

A handy scanner according to the first embodiment will be described with reference to the figures.

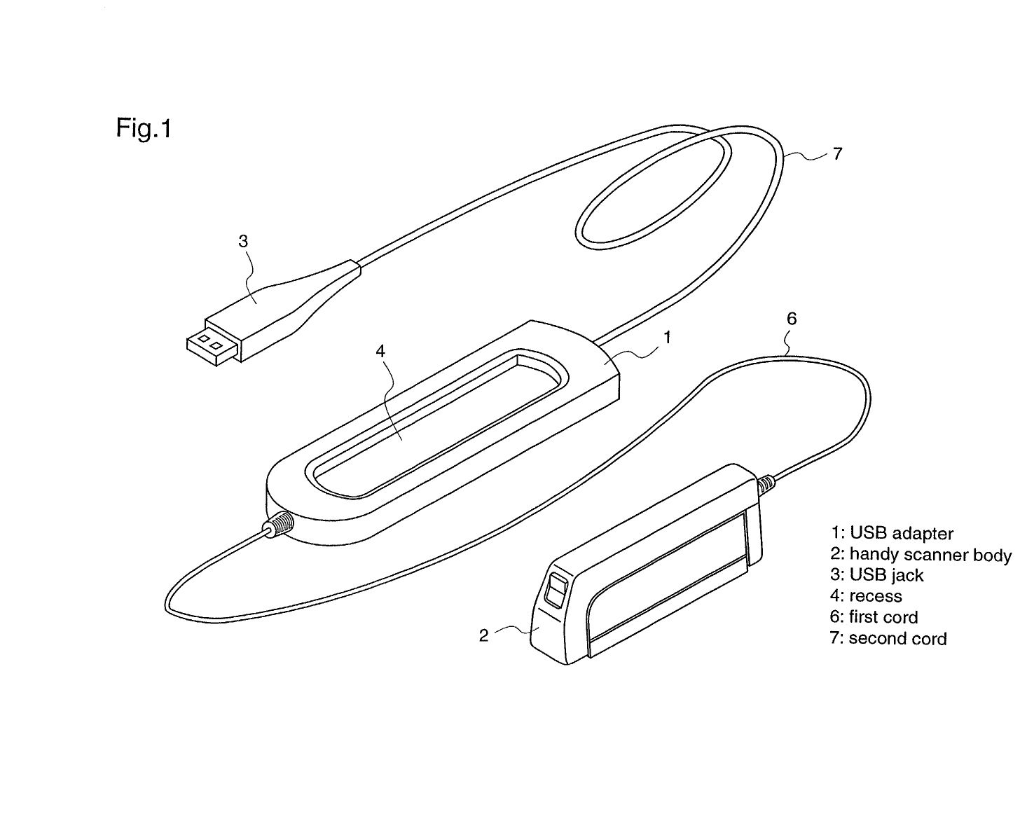

Initially, the structure of a relay box according to the first embodiment is described. FIG. 1 is a diagram illustrating a handy scanner according to the first embodiment.

In FIG. 1, numeral 1 denotes a USB adapter as a relay box, which converts image signals read by the handy scanner so as to be compliant with USB interface of a device such as a personal computer. Numeral 2 denotes a handy scanner body which includes a transparent glass (not shown) as a read section on its bottom surface. Numeral 3 denotes a USB jack as a terminal which is connected to a USB terminal included in a device such as a personal computer. Numeral 4 denotes a recess of the USB adapter 1, which can receive the handy scanner body 2. Numeral 6 denotes a first cord which connects the handy scanner body 2 and the USB adapter 1 with each other. This first cord can be detached from the USB adapter 1 and the handy scanner body 2. Numeral 7 denotes a second cord which connects the USB adapter 1 and the USB jack 3 with each other. This second cord can be detached from the USB adapter 1. In addition, an interfering electromagnetic wave reduction noise filter (not shown) is contained in the USB adapter 1.

Next, the operation of the relay box according to the first embodiment is described.

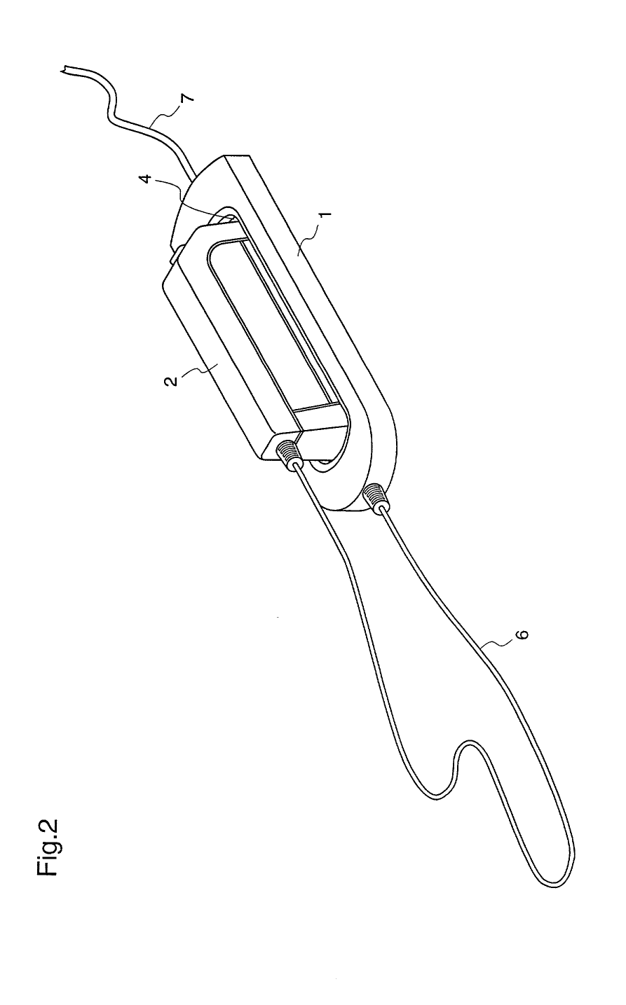

FIG. 2 is a diagram illustrating a state where the handy scanner body is mounted on the relay box according to the first embodiment.

In order to establish a USB interface connection between the handy scanner and a personal computer, the USB jack 3 is connected to the USB terminal of the personal computer. The handy scanner body 2 reads image light of an original through the transparent glass as a read section, which is located on the bottom surface, and signalizes the same. The image signal which is obtained by signalizing the image light goes through the first cord 6, the USB adapter 1 and the second cord 7, and is input to the personal computer via the USB jack 3. The USB adapter 1 converts the image signal of the image light which is read by the handy scanner body 2 so as to be compliant with the USB interface. The personal computer carries out processing such as retaining the converted signal or reading the signal to display the same on the display screen. Here, the USB adapter 1 contains the interfering electromagnetic wave reduction noise filter, which can prevent influences of the electromagnetic waves upon the image signals. This noise filter is made of ferrite and absorbs the interfering electromagnetic waves.

When the handy scanner body 2 is not used, the bottom part of the handy scanner body 2 is fitted into the recess 4 which is disposed on the USB adapter 1, as shown in FIG. 2. With this structure, the handy scanner body 2 can be received by the recess 4 of the USB adapter 1. For example, in a state where the handy scanner body 2 is received by the recess 4 of the USB adapter 1, when one of the connection parts of the first cord 6 is disconnected and the first cord is wrapped around the periphery of the received handy scanner, the handy scanner can be accommodated more compactly, whereby it can be carried easily.

The USB adapter 1 can be provided also with a fastener to fix the handy scanner body 2 in a state where the scanner body 2 is received by the USB adapter 1.

As described above, the handy scanner as described in the first embodiment comprises the handy scanner body having the transparent glass as the read section on its bottom surface; the relay box for relaying signals between the handy scanner body and a device; the first cord for connecting the handy scanner body and the relay box with each other; the terminal for establishing connection with the device; and the second cord for connecting the relay box and the terminal with each other, the relay box has the recess in which the handy scanner body can be received; and the fastener for fixing the handy scanner body in a received state, the handy scanner body can be mounted on the relay box and fixed therewith, and the relay box contains the interfering electromagnetic wave reduction noise filter. Therefore, when the handy scanner body is not used, the handy scanner body is mounted on the recess of the relay box, thereby protecting the transparent glass for reading images, which is disposed on the bottom surface of the handy scanner body, and preventing dirt or scratches. In addition, when the handy scanner is to be carried, the handy scanner body and the relay box can be carried integrally in a state where the handy scanner body is mounted on the relay box.

Further, since the interfering electromagnetic wave reduction noise filter is contained in the relay box, it is not required to attach the noise filter to the connection cord.

Here, the relay box can be the one other than the USB adapter, as long as it is an adapter or the like which connects the handy scanner body and the device with each other.

Further, while the personal computer is shown as an example of the device, any device other than the personal computer can be used.

What is claimed is:

1. A handy scanner comprising:
a handy scanner body having a read section on a bottom surface thereof;
a relay box for relaying signals between the handy scanner body and a device;
a first cord for connecting the handy scanner body and the relay box with each other;
a terminal for establishing connection with the device; and
a second cord for connecting the relay box and the terminal with each other,
said handy scanner body being mounted on said relay box.

2. The handy scanner of claim 1
wherein the relay box has a recess which receives the handy scanner body.

3. The handy scanner of claim 1
wherein the relay box contains an interfering electromagnetic wave reduction noise filter.

4. The handy scanner of claim 2
wherein the relay box comprises a fastener for fixing the handy scanner body in a state where the handy scanner body is received in the recess.
